(19) United States
(12) Patent Application Publication
(10) Pub. No.: US 2010/0263409 A1
(43) Pub. Date: Oct. 21, 2010

(54) PROCESS FOR GLASS SURFACE MODIFICATION

(75) Inventors: Markku Rajala, Vantaa (FI); Mika Immonen, Helsinki (FI); Jukka Santahuhta, Hameenlinna (FI); Timo Akerlund, Helsinki (FI)

Correspondence Address: OLIFF & BERRIDGE, PLC, P.O. BOX 320850, ALEXANDRIA, VA, 22320-4850, US

(73) Assignee: BENEQ OY, Vantaa (FI)

(21) Appl. No.: 12/744,566

(22) PCT Filed: Dec. 8, 2008
(86) PCT No.: PCT/FI08/00140

§ 371 Date: Jun. 23, 2010

(30) Foreign Application Priority Data
Dec. 20, 2007 (FI) 20071000

(51) Int. Cl. C03C 21/00

(52) U.S. Cl. 65/30.13

(57) ABSTRACT

Process for a fast ion-exchange between an alkaline metal ion in glass and another ion in gas atmosphere, in which process the glass surface is heated with a flame and the ion exchange takes part at the portion heated by the flame essentially simultaneously with heating. The process is fast enough to be integrated to a glass manufacturing or processing line.

### TECHNICAL FIELD

The invention relates to a process for modifying glass surface, especially to the modification of the glass surface by ion exchange, in which process the ion exchange can be carried out fast. This makes the process proper for integration with the glass manufacturing process, like the float process, or with glass processing.

### BACKGROUND ART

Ion exchange is a conventionally used process for improving the mechanical strength of glass or for coloring glass red or yellow by copper or silver. In glass coloring a copper or silver salt is mixed with a suitable medium and water is added to the mixture to prepare slurry with a suitable viscosity. The slurry is spread on the glass substrate and the substrate is heated, typically to a few hundred degrees Celsius so that the glass is colored by ion exchange. The ion exchange time is typically from several minutes to several hours. After the ion exchange process the dried slurry is washed or brushed away from the glass surface. The method is not suitable for large-scale industrial production.

Publication U.S. Pat. No. 1,977,625, E.I. du Pont de Nemours and Company, Oct. 23, 1934, describes a process for the decoration of ceramic ware having a surface susceptible of cracking or breaking when hot on the application of cold which comprises spraying said ceramic ware with a liquid preparation comprising a noble metal constituent, a flux and a reducing agent while said ware is at a temperature above the critical point at which cracks or breaks are likely to develop and at such temperature at which the coating will flux to the surface but below the temperature at which deformation begins. For soda lime glass the critical temperature is about 600 to 750° C. The use of flux will decrease the mechanical and chemical durability of the glass surface and thus the method is not generally applicable to flat glass.

Publication U.S. Pat. No. 2,075,446, Corning Glass Works, Mar. 30, 1937, describes a method for treating alkaline-containing glass articles, which includes causing a rapid exchange of alkali ions contained in the surface of the glass with staining ions contained in a molten staining salt into which the glass surface is dipped. The dipping-phase makes the method unsuitable for ion-exchange during float glass manufacturing.

Publication U.S. Pat. No. 2,428,600, Glass Science, Incorporated, Oct. 7, 1947, describes a method of staining glass with copper which comprises subjecting a hot, alkali-containing glass surface to the action of vapors of a volatile copper halide which will react with the alkali of the glass surface with replacement of alkali ions of the surface of the glass with copper ions, and subsequently subjecting the glass containing copper within the glass surface to reduction with hydrogen at an elevated temperature. The glass temperature is 350-550° C. and the method does not include glass surface, heating.

Publication U.S. Pat. No. 2,662,035, Verd-A-Ray Processing Company, Dec. 8, 1953, describes a method of staining like, lead and borosilicate glass surfaces which comprises forming a finely divided, uniform aqueous dispersion containing copper, silver and zinc salts and a water soluble inorganic chloride compound in amounts sufficient to stain glass, an in defined proportions of different metals coating a glass surface with a dispersion, and heating the coated glass surface to at least 800° F. (427° C.), but not more than 1100° F. (593° C.) to produce a stained glass surface. Heating is carried out in a furnace and typical heating times are several minutes. The method is not applicable to on-line glass surface modification.

Publication U.S. Pat. No. 3,615,322, Anchor Hocking Glass Corporation, Oct. 26, 1971, describes a method of flame treating and strengthening a glass article having exchangeable ions, said method comprising forming the article with an area thereon which is to be flame treated, exchanging at least a portion of the sodium ions in said area of said article with cuprous ions from a source external to said article, at a temperature above the annealing point of said article, thereby altering the composition of said article in a surface zone in said area, flame treating said area after said ion exchange has taken place, then cooling the formed, flame treated article, thereby strengthening it. The ion exchange times described in the publication are several tens of minutes, which make the process unsuitable for integration to glass manufacturing or other glass processing processes, like glass tempering.

Publication U.S. Pat. No. 3,645,710, Glaverbel S. A., Feb. 29, 1972, describes a process for modifying a property of the material of at least one surface of a body of a material having at least one vitreous phase, comprising contacting at least a selected portion of the body surface with a gaseous substance whose ions are capable of diffusing into the material, at least partly ionizing such substance by subjecting it, in the immediate vicinity of the surface portion, to an electric arc discharge of sufficient energy to ionize the substance, the discharge being located entirely to that side of the body at which such surface is disposed and following a trajectory which extends substantially parallel to the surface at least in the region where it is nearest the surface, and maintaining such substance in an ionized state in the immediate vicinity of such portion of the surface under conditions which cause such ions to diffuse into the body surface. Maintaining the substance in an ionized state may be carried out by a flame. The publication does not describe heating the glass surface by the flame, but only describes that the ionizing means may also be constituted by a burner delivering a flame.

Publication U.S. Pat. No. 3,967,040, Glaverbel-Mecaniver, Jun. 29, 1976, describes a process for imparting a desired coloration to a body of ordinary soda-lime-silica glass which is free of phosphorous pentoxide and formed from a vitrifiable composition, by diffusing a substance into surface layers of the body from a medium contacting the body, comprising the steps of: introducing a reducing agent into such surface layers by diffusion starting from the outer surface of the body, to cause such agent to be concentrated in such layers in an amount of at least 1% by weight; placing the body surface, after said step of introducing, into contact with such a medium composed of a mixture of (a) a salt furnishing reducible silver metal ions in an amount sufficient to impart coloration to the body, and capable of being reduced by the reducing agent and (b) a diluting agent constituted by a salt of another metal, furnishing metal ions which diffuse into the body in exchange for smaller ions initially present in the body, the total concentration in the medium of the salt furnishing reducible silver metal ions being less than one hundred parts per million; and during said step of placing, maintaining the surface layer at a temperature which causes such reducible silver metal ions to diffuse into the body surface layers and to be chemically reduced by the reducing agent and such ion exchange to induce in surface layers of the body compressive stresses which are prevented from relaxing entirely during the course of said step of placing, said diffusion of reducible metal ions and said ion exchange occurring simultaneously. No glass surface heating with a flame is mentioned in the publication.

Publication U.S. Pat. No. 5,127,931, Schott Glaswerke, Jul. 7, 1992, describes a process for ion exchange at the surface of glass where the ion exchange is carried out by means of a solid layer containing mainly one or more salts which do not melt at the exchange temperature and contain mono- or divalent cations. The salt film can be applied to the glass surface by conventional methods, like by electrostatic forces, spraying or dipping. Typical ion exchange times mentioned in the publication are several hours, which make the process unsuitable for integration to glass manufacturing or other glass processing processes, like glass tempering.

Publication U.S. Pat. No. 5,837,025, Schott Glaswerke, Nov. 17, 1998, describes a method of producing low sintering fine-particle multicomponent glass powder having a particle size of the primary particle in the nanometer range. The method is able to generate color decorations on glass after adding a color pigment to the glass flow. The method thus adds a colored film on the glass surface and does not modify the glass surface.

The problem in the prior art is that the ion exchange process is slow, which makes the prior art processes unsuitable for integration to contemporary industrial production and processing of glass, especially for flat glass production and processing.

### DISCLOSURE OF INVENTION

The main purpose of the present invention is to introduce a method to be used in the modification of glass surface by a fast ion exchange process which overcomes the problems of the prior art. The inventors have surprisingly found that if the ion exchange process is carried out under the influence of an essentially impinging flame heating the glass surface, the ion exchange process can be carried out very fast, typically in a few seconds or even in less than a second. The process is characterized in the characterizing portion of claim 1, which states that a flame is directed essentially towards the glass surface, the maximum temperature of the flame being at least 1000° C. The flame heats up at least a portion of the glass surface and the ion exchange happens essentially at the portion. The ion exchange happens between an alkali metal in the glass and an element which is introduced into the flame.

Heating the glass surface with a flame heats the glass surface essentially convectively. The glass surface, up to 1 mm depth from the surface heats to 50-500° C. higher temperature than the bottom of the glass. As the temperature of the glass bottom does not essentially increase, the glass body can be transferred in the roller lines or equivalent typically found in the glass processing equipment or in the A0 sector of a float line (the A0 sector lays between the tin bath and the annealing lehr). At least one element is introduced to the flame. The element is typically a metal, like noble metal, transition metal, alkaline metal, alkaline-earth metal, or similar. Typically the element is introduced into a flame as a compound, e.g. as a metal salt. The compound is ionized in the flame. The ion exchange reaction between the element in the flame and the alkaline metal in the glass happens essentially at the portion where the flame heats the glass surface. As the glass surface is hot, the ion exchange rate is much faster than in the prior art technologies.

We have found that it is advantageous to the ion exchange process that the alkaline metal escaping from the glass reacts with a component in the flame, like sodium reacting with chlorine and forming sodium chloride. Sodium chloride solidifies immediately outside the vicinity of the flame and thus sodium ion is removed from the gas phase keeping the concentration gradient (from glass to the gas phase) remains high and the ion exchange rate remains high as well. The chlorine ion may also react with various other ions, like nitrate-, carbonate-, or sulphate ion.

The said element is beneficially one of the followings, but the list does in no way limit the process to these elements only: silver (which colors glass yellow), gold (which colors glass red), cobalt (which colors glass blue), chrome (which colors glass green), iron (which colors glass blue-green), manganese (which colors glass violet), nickel (which colors glass grey), potassium (which improves the mechanical durability of glass), aluminum (which improves the chemical durability of glass) or zirconium (which improves the chemical durability of glass). In addition to the non-limitability of the list, it is obvious to a person skilled in the art that more than one element in the flame can take part in the ion exchange process.

The flame is advantageously an oxy-hydrogen flame. The adiabatic flame temperature of such flame is about 2700° C. and the flame has no radiating component and thus heats the glass surface only by convection. It is, however, also possible to heat the glass surface with a flame where the fuel is a hydrocarbon, like methane, ethane, propane, butane or similar, or where the fuel comprises carbon, like carbon monoxide. The fuel gas or the oxidizing gas of the flame may also include, as a gaseous or vapor compound, the element taking part in the ion exchange. Such vapor or gas may also be fed into the flame from a separate feeding tube.

The flame may also be produced by burning an exothermic liquid, like methyl alcohol, ethyl alcohol, diesel oil, gasoline or similar. In such case it is advantageous to atomize the liquid to fine droplets before the flame is ignited. In the most advantageous case the droplets are very small, typically having a mean diameter of less than 10 micrometers, so that the burning rate of the flame is high.

The flame temperature must be high enough for at least partial ionization of the compound comprising the element for ion exchange. Typically the flame temperature must exceed 1000° C. In the preferred embodiment of the invention, the flame impinges the glass surface.

The liquid used to generate the flame may also include the said element, which is an advantageous way for feeding the element into the flame. In one embodiment of the invention silver nitrate is dissolved into methyl alcohol and the solution is used to generate the flame and simultaneously feed the said element into the flame.

It is obvious for a person skilled in the art that the flame may also be generated by combining the gaseous and liquid fluid in a wide variation range and that a same or different element may be introduced into the flame either in gaseous, vapor or liquid form.

The said element may also be introduced to the flame from a solid precursor, from which the element is liberated either by the heat generated by the flame or by a chemical reaction caused by the substances in or essentially in the surrounding area of the flame. The inventors have found that silver vapor or silver ions can be liberated from a solid silver source situated in the essential vicinity of the flame, if some chlorine or chlorine compound is fed into the flame. The liberated silver ions can participate in the ion exchange process.

### BRIEF DESCRIPTION OF DRAWINGS

In the following, the invention will be described in more detail with reference to the appended principle drawings, in which

FIG. 1 shows an embodiment, in which the said element is fed into the flame in liquid form,

FIG. 2 shows an embodiment, in which the element is liberated from a solid source,

FIG. 3 shows two embodiments, for improving the mechanical and chemical durability of glass.

For the sake of clarity, the figures only show the details necessary for understanding the invention. The structures and details which are not necessary for understanding the invention and which are obvious for anyone skilled in the art have been omitted from the figures in order to emphasize the characteristics of the invention.

### MODES FOR CARRYING OUT THE INVENTION

According to the invention, the flame is directed essentially towards the glass surface, the maximum temperature of the flame being at least 1000° C. The flame heats up at least a portion of the glass surface and the ion exchange happens essentially at the portion. The ion exchange happens between an alkaline metal in the glass and an element which is introduced into the flame.

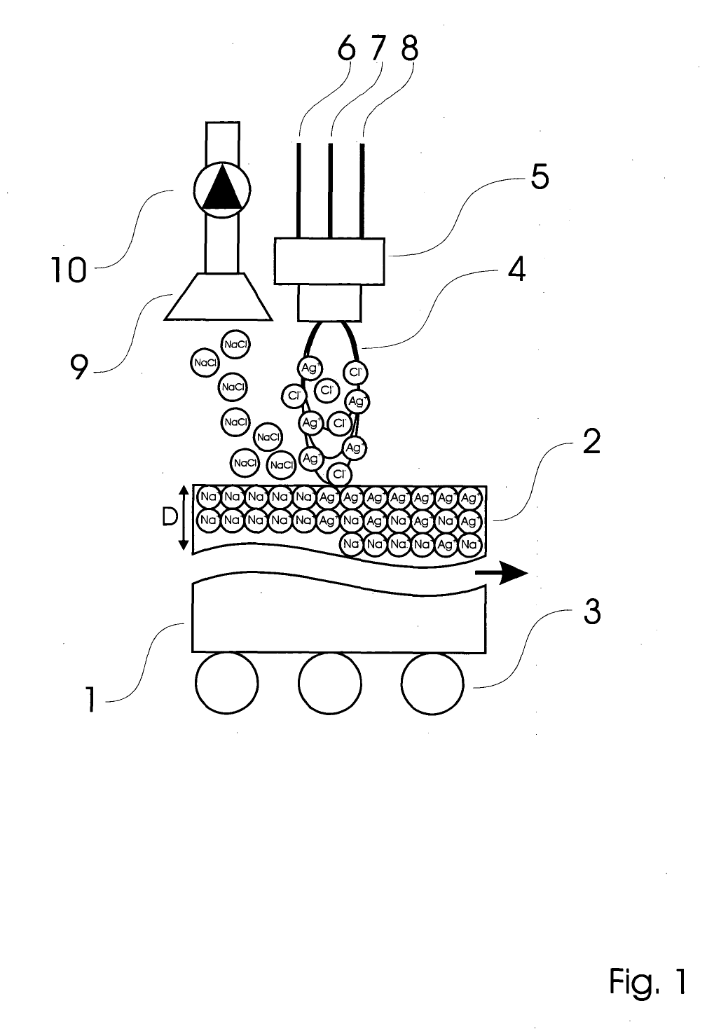

FIG. 1 shows, in principle, an embodiment of the invention, where the sodium ions Na⁺ on the top surface 2 of glass 1 are exchanged to silver ions Ag⁺. Glass 1 moves to the direction of the arrow on rollers 3. Glass top surface 2 is heated by an impinging flame 4 which is produced by a burner 5 burning fuel 6, which is advantageously hydrogen, with an oxidizing gas 7, which is advantageously oxygen. The top surface 2 heats up due to the convective heat transfer caused by the flame 4 to a depth D, which is advantageously less than 1 mm. Obviously heat will be transferred, by conduction, also further in glass 1, but as the glass 1 passes quite fast through flame 1, the total heat energy will be small and thus the temperature of the bottom surface of glass 1 will only increase slightly, typically only few ° C. Silver chloride is mixed with methyl alcohol and the mixture is fed through channel 8 and atomized in burner 5 prior to feeding into flame 4. The composition of the precursor mixture is typically 1:10-1:100 silver chloride: methyl alcohol and advantageously 1:20. The mixture is prepared by conventional chemical methods. The diameter of the atomized droplets is advantageously less than 10 micrometers, so that the evaporation time is short and the burn rate high. Glass 1 is heated before entering flame 4 and the glass temperature must be above the glass annealing point, which for soda-lime glass is about 520° C. In the float process glass temperature is between 520° C. and 650° C. at zone A0, which is the zone between the tin bath and the annealing lehr. In glass tempering glass is heated to about 650° C. Thus both of these processes are suitable for the integration of the described invention to the process. Flame 4 heats the glass top surface so that the surface temperature increases 50-500° C., advantageously 100-200° C. In a preferred embodiment flame 4 heats the glass top surface 2 mostly by convection and thus heating the whole glass body is minimized. In the most preferred embodiment flame 4 is generated by hydrogen and oxygen. In the flame 4 silver chloride decomposes to silver ions Ag⁺ and chlorine-ions Cl⁻. At least a fraction of the silver ions Ag⁺ is exchanged to sodium ions Na⁺ emerging from glass 1 due to a diffusion-based ion exchange mechanism. The rate of the ion exchange process is a strong function of temperature. As the flame 4 heats the top surface 2 of glass 1, the ion exchange process is fast and can be carried out at typical float line glass ribbon speed (5-20 m/min) or glass processing flat glass feeding rates (1-50 m/min). The glass does not, however, deform, because the temperature of the bottom surface of glass 1 does not increase significantly. At least a fraction of sodium ions Na⁺ which exit from glass 1 reacts with chlorine ions Cl⁻ in the flame or in the essential vicinity of the flame forming sodium chloride NaCl. The boiling point of sodium chloride is over 1400° C. and the melting point is over 800° C. and thus in the peripheral area of flame 4 and outside the flame 4 sodium is removed from the gas phase. Thus the concentration of sodium ions Na⁺ in the flame remains small and the rate of ion exchange remains high. Sodium chloride is exhausted through the hood 9 and blower 10. In the top surface of glass 2 at least a portion of sodium ions Na⁺ is exchanged to silver ions Ag⁺.

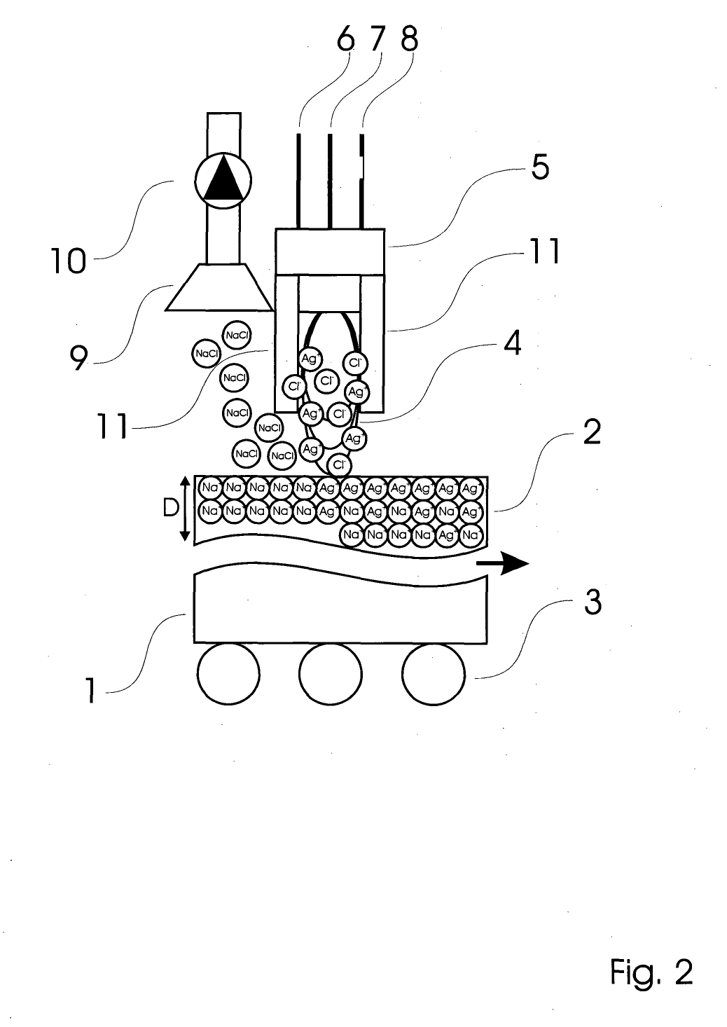

FIG. 2 shows, in principle, another embodiment of the invention. Glass 1 moves to the direction of the arrow on rollers 3. Glass top surface 2 is heated by an impinging flame 4 which is produced by a burner 5 burning fuel 6, which is advantageously hydrogen, with an oxidizing gas 7, which is advantageously oxygen. The top surface 2 heats up due to the convective heat transfer caused by the flame 4 to a depth D, which is advantageously less than 1 mm. Obviously heat will be transferred, by conduction, also further in glass 1, but as the glass 1 passes quite fast through flame 1, the total heat energy will be small and thus the temperature of the bottom surface of glass 1 will only increase slightly, typically only few ° C. Hydrogen chloride (HCl) is mixed with water and the mixture is fed through channel 8 and atomized in burner 5 prior to feeding into flame 4. The HCl concentration in the mixture is typically 10%. The diameter of the atomized droplets is advantageously less than 10 micrometers, so that the evaporation time is short. Glass 1 is heated before entering flame 4 and the glass temperature must be above the glass annealing point, which for soda-lime glass is about 520° C. In the float process glass temperature is between 520° C. and 650° C. at zone A0, which is the zone between the tin bath and the annealing lehr. In glass tempering glass is heated to about 650° C. Thus both of these processes are suitable for the integration of the described invention to the process. Flame 4 heats the glass top surface so that the surface temperature increases 50-500° C., advantageously 100-200° C. In a preferred embodiment flame 4 heats the glass top surface 2 mostly by convection and thus heating the whole glass body is minimized. In the most preferred embodiment flame 4 is generated by hydrogen and oxygen. Chlorine-ions or chlorine compounds formed in the flame are capable of removing silver from the solid source 11 comprising silver, and typically silver chloride or other silver compounds are formed. In the flame 4 silver compound decomposes to silver ions Ag⁺ and chlorine-ions Cr. At least a fraction of the silver ions Ag⁺ is exchanged to sodium ions Na⁺ emerging from glass 1 due to a diffusion-based ion exchange mechanism. The rate of the ion exchange process is a strong function of temperature. As the flame 4 heats the top surface 2 of glass 1, the ion exchange process is fast and can be carried out at typical float line glass ribbon speed (5-20 m/min) or glass processing flat glass feeding rates (1-50 m/min). The glass does not, however, deform, because the temperature of the bottom surface of glass 1 does not increase significantly. At least a fraction of sodium ions Na⁺ which exit from glass 1 reacts with chlorine ions Cl⁻ in the flame or in the essential vicinity of the flame forming sodium chloride NaCl. The boiling point of sodium chloride is over 1400° C. and the melting point is over 800° C. and thus in the peripheral area of flame 4 and outside the flame 4 sodium is removed from the gas phase. Thus the concentration of sodium ions Na⁺ in the flame remains small and the rate of ion exchange remains high. Sodium chloride is exhausted through the hood 9 and blower 10. In the top surface of glass 2 at least a portion of sodium ions Na⁺ is exchanged to silver ions Ag⁺.

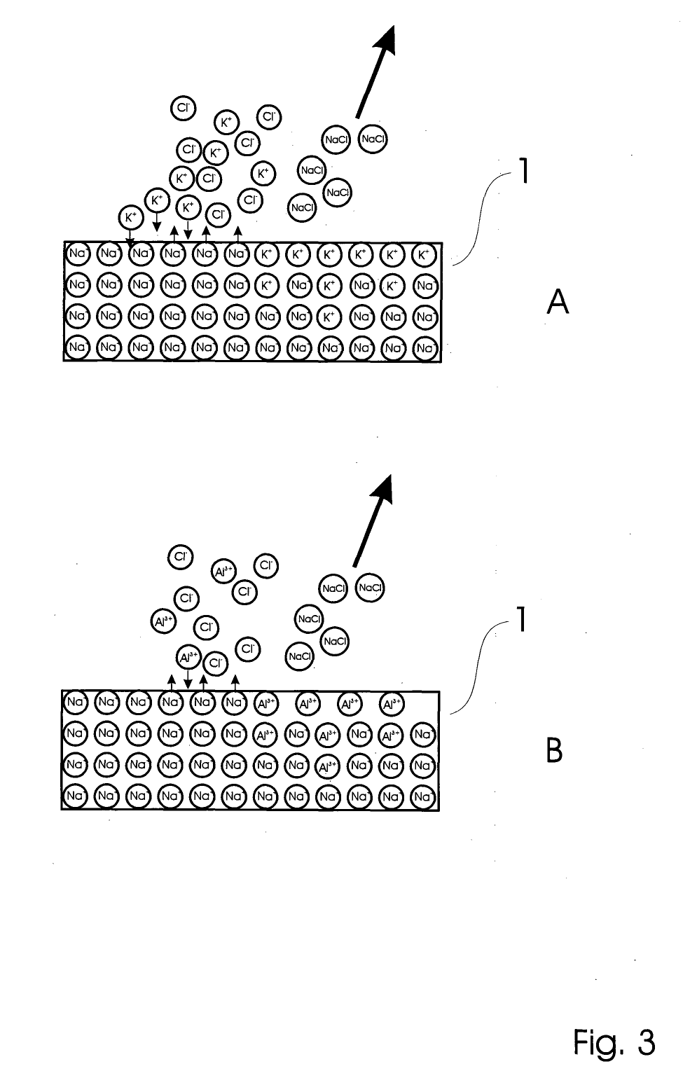

FIG. 3 shows, in principle, two other ion exchange processes, where the invention can be applied. FIG. 3A shows a process where the sodium ions Na⁺ in the glass are exchanged to potassium ions K⁺. Potassium ions on the top layer of glass increase the mechanical durability of glass. Potassium ions are introduced into the flame by dissolving potassium nitrate to distilled water (roughly 30 g of potassium nitrate to 100 g of water) and atomizing the mixture to the flame through the burner 5. FIG. 3B shows a process where the sodium ions Na⁺ in the glass are exchanged to aluminum ions Al³⁺. Aluminum on the top layer of glass increases the chemical durability of glass. Aluminum ions are introduced into the flame by dissolving aluminum nitrate to methyl alcohol (roughly 10 g of aluminum nitrate to 100 g of methyl alcohol) and atomizing the mixture to the flame through the burner 5.

The described invention enables a fast ion exchange process capable for integration to glass production process, like float process or to glass processing, like glass tempering.

By combining, in various ways, the modes disclosed in connection with different embodiments of the invention presented above, it is possible to produce various embodiments of the invention in accordance with the spirit of the invention. Therefore, the above-presented examples must not be interpreted as restrictive to the invention, but the embodiments of the invention can be freely varied within the scope of the inventive features presented in the claims herein below.

1-12. (canceled)

13. An ion-exchange process where at least a fraction of alkaline metals on a glass body are exchanged to the ions of another element, comprising
a) heating at least a portion of the surface of the glass body with a flame; and
b) feeding a compound comprising said other element essentially into the flame; so
c) that the ion exchange process between the alkaline metal and the said another element takes place essentially at the said portion essentially during heating;
wherein the flame heats the glass top surface at least 50° C. above the glass bottom surface temperature.

14. The process of claim 13, wherein the alkaline metal ion escaping from the glass body reacts chemically with another ion essentially in the flame.

15. The process of claim 14, wherein the said another ion is chlorine-ion, nitrate-ion, carbonate-ion or sulphate-ion.

16. The process of claim 13, wherein the said another element is silver, potassium, cobalt, chrome, iron, copper, gold, manganese, nickel, aluminum or zirconium.

17. The process of claim 13, wherein the flame is an oxy-hydrogen flame.

18. The process of claim 13, wherein the process comprises using liquid fuel which is atomized prior to flame ignition.

19. The process of claim 18, wherein the mean droplet diameter of the atomized fuel is less than 10 micrometers.

20. The process of claim 18, wherein the liquid fuel is a solution including the said another element.

21. The process of claim 13, wherein the process comprises feeding the said another element to the flame in a gaseous or vapor form.

22. The process of claim 13, wherein the process comprises feeding the said another element to the flame as an atomized liquid.

23. The process of claim 13, wherein the process comprises releasing the said another element from a solid source comprising said another element with the flame or with a reactive component in the flame.

24. The process of claim 19, wherein the liquid fuel is a solution including the said another element.
